(19) United States
(12) Patent Application Publication
(10) Pub. No.: US 2006/0146532 A1
(43) Pub. Date: Jul. 6, 2006

(54) Lighting box

(75) Inventors: Erland Austreng, Solfallskroken (NO); Kjell-Arne Rorvik, Oslo (NO); William Mikkelsen, Drobak (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: Akvaforsk Institutt for akvakulturforskning AS, As (NO)

(21) Appl. No.: 10/533,825

(22) PCT Filed: Nov. 7, 2003
(86) PCT No.: PCT/NO03/00376

§ 371 Date: Dec. 21, 2005

(30) Foreign Application Priority Data
Nov. 8, 2002 (NO) 20025363

(51) Int. Cl. F21V 1/00

(52) U.S. Cl. 362/248

(57) ABSTRACT

An illumination box for true, reproducible colour reproduction of an object, comprising side walls, a top plate and a bottom plate, wherein between the top plate and the bottom plate there is provided a light diaphragm which divides the illumination box into a light chamber above the light diaphragm and an object chamber beneath the light diaphragm, which light diaphragm admits and diffuses light from a plurality of light sources arranged in the light chamber, characterised in that the light diaphragm is attached to an essentially light-impenetrable screening frame adjacent to the side walls, with the plurality of light sources distributed along the side walls at a distance from the side walls and from the screening frame such that an area for placement of the object is screened from essentially all direct light from the plurality of light sources, and that an aperture is provided in the object chamber for observation of the object.

The present application relates to an illumination box according to the preamble of independent claim 1.

A previously known illumination box is the so-called “Skretting box” (Salmon Colour Box, Skretting, Stavanger). This box is used by the Applicant to illuminate objects, in the form of salmon, for visual colour classification, and consists of an upper closed light chamber in which a plurality of fluorescent tubes are arranged, and a lower object chamber which is open in one of the sides for the insertion, observation and withdrawal of objects. A light diaphragm for diffusing the light from the fluorescent tubes is provided between the light chamber and the object chamber.

The colour of light is a function of its electromagnetic wavelength. Seven distinctive said colours can be distinguished from each other in the visible light spectrum, each representing a separate wavelength. These are red, orange, yellow, green, blue, indigo and violet. As known, absence of light in any colour results in black. A combination of the three primary light colours red, green and blue gives white light. Colours can be classified using different systems. The RGB system is one such system, where the letters R, G and B stand for red, green and blue respectively. The LAB system can be derived from the RGB system, or vice versa, and the letters L, A, and B define lightness, redness and yellowness respectively.

True colour reproduction when taking photographs requires uniform illumination of the object (so-called flat light or 0 light), and a problem with the Skretting box is that the illumination of the object is not sufficiently uniform for such colour reproduction. Another problem is that the open side of the box reflects light from the surroundings onto the object, which has a further adverse effect on the true colour reproduction of the object.

To solve the aforementioned problems, the present invention provides an illumination box as disclosed in the characterising clause of independent claim 1. Advantageous embodiments of the invention are set forth in the dependent claims.

The present invention is described in more detail in the following description with reference to the attached drawings, wherein:

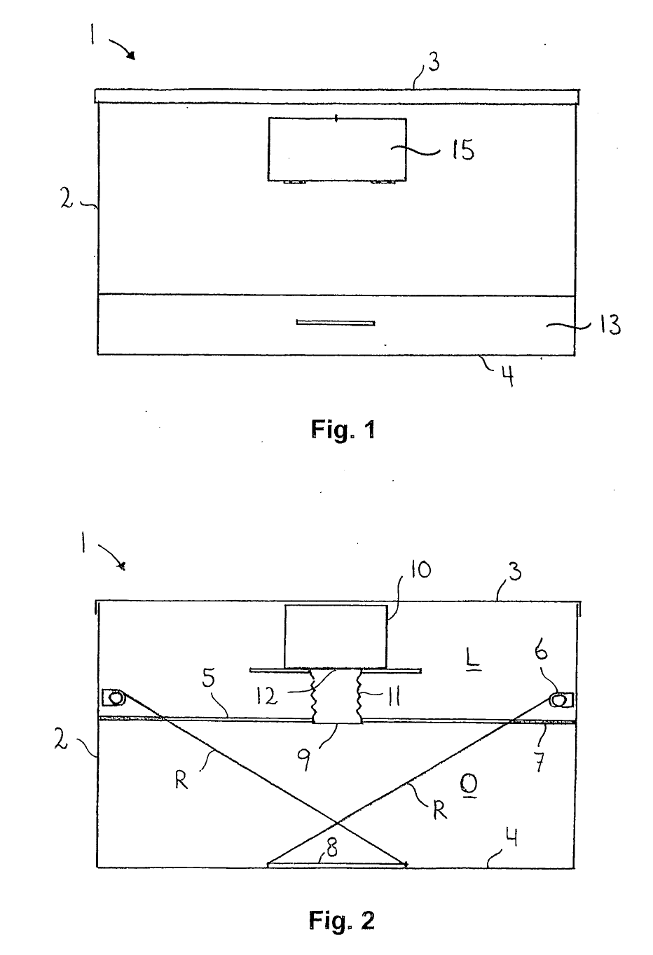

FIG. 1 is a side view of the illumination box according to the present invention;

FIG. 2 is a sectional view of the illumination box in FIG. 1;

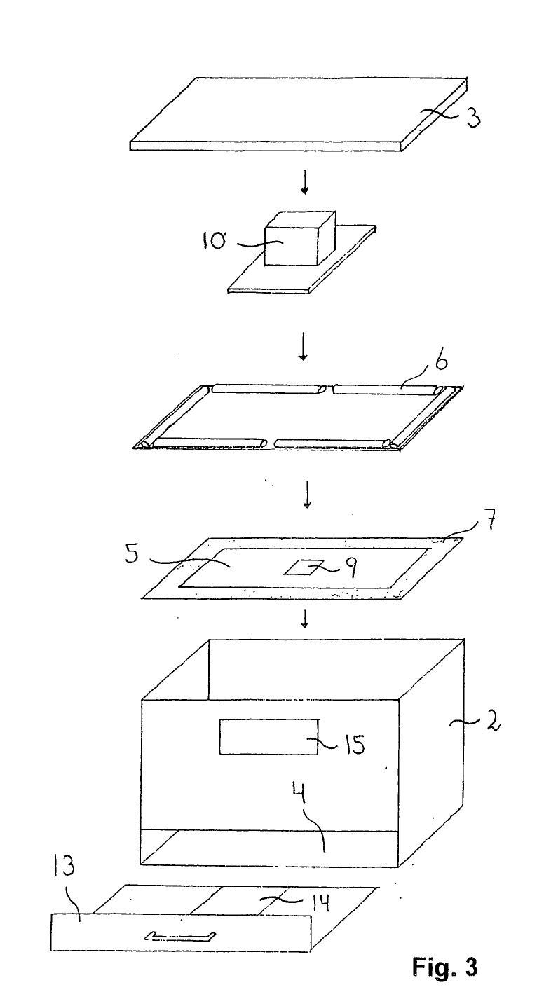

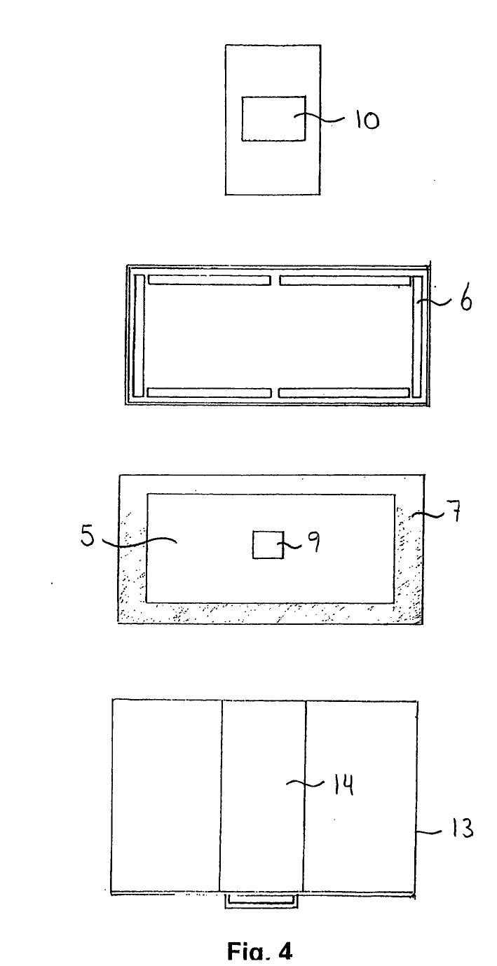

FIG. 3 is a split view of the illumination box in FIG. 1;

FIG. 4 is a top view of some of the parts in FIG. 3;

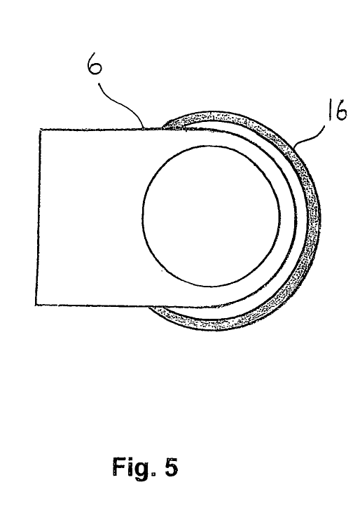

FIG. 5 is an enlarged side view of one of the fluorescent tubes in FIGS. 1-4;

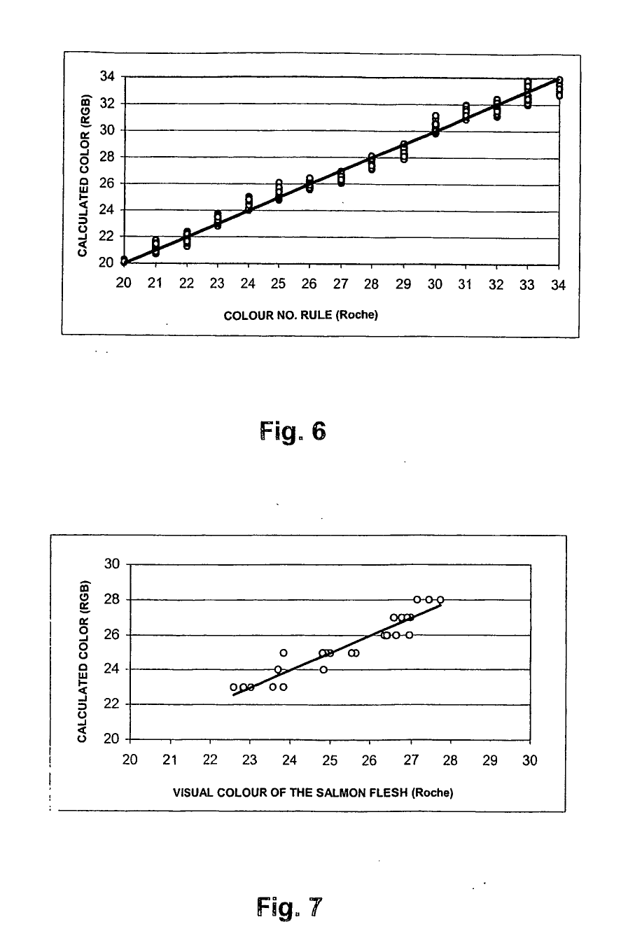

FIG. 6 is a graph showing the relationship between calculated colour number and colour number in the Roche colour rule;

FIG. 7 is a graph showing the relationship between visual colour evaluation and predicted colour based on RGB values;

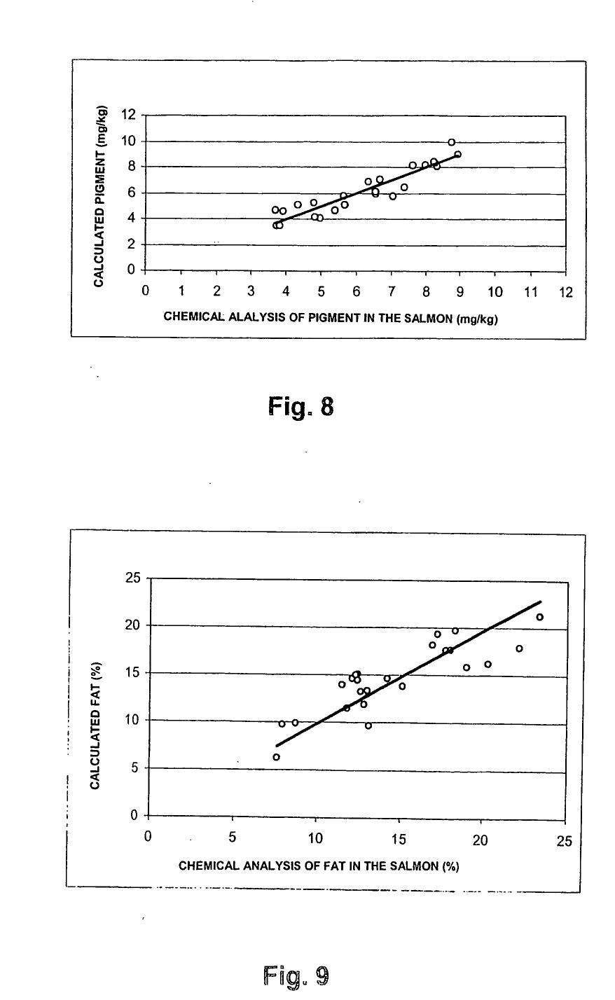

FIG. 8 is a graph showing the relationship between chemical content of pigment in salmon and predicted values based on RGB measurements;

FIG. 9 is a graph showing the relationship between fat content in salmon and predicted values based on RGB measurements; and

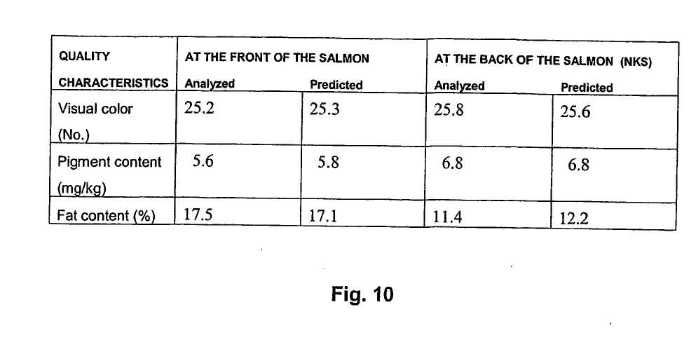

FIG. 10 is a table showing average values for visual colour, chemical pigment, analysed and predicted, at the front and the back of a salmon.

FIGS. 1-5 show an illumination box 1 according to the present invention, for true, reproducible colour reproduction of an object. The illumination box 1 comprises side walls 2, a top plate 3 and a bottom plate 4. Between the top plate 3 and the bottom plate 4, and essentially parallel to at least the bottom plate 4, there is provided a light diaphragm 5 which divides the illumination box 1 into a light chamber L above the light diaphragm 5 and an object chamber O beneath the light diaphragm 5. The light diaphragm 5, preferably made of the diffuser material Opal plastic, admits and diffuses light from a plurality of light sources, preferably fluorescent tubes 6, arranged in the light chamber L. The light diaphragm 5 is attached to an essentially light-impenetrable screening frame 7 adjacent to the side walls 2, with the plurality of fluorescent tubes 6 distributed along the side walls 2 at a distance from the side walls 2 and from the screening frame 7 such that an area 8 for placement of the object is screened from essentially all direct light from the fluorescent tubes 6, indicated by the border lines R in FIG. 2. The fluorescent tubes are preferably of a type corresponding to Osram No. 12-950 (55W, about 5800 Kelvin). An access hatch 15 for access to the light chamber L is also shown in FIGS. 1 and 3. During use, the illumination box 1 is essentially closed to incoming external light.

An aperture 9 for observation of the object is also provided in the object chamber O. The aperture 9 shown in the figures is located in a central area of the light diaphragm 5 for photographing the object with a camera 10 located in the light chamber L, there being provided light-impenetrable, non-reflecting means 11 in the form of a black bellows which forms a channel between the lens aperture 12 of the camera 10 and the aperture 9 in the light diaphragm 5.

The bottom plate 4 in the object chamber is preferably provided with a drawer 13 for the insertion and withdrawal of the object. A loose tray 14 is preferably provided in this drawer for placement of the objects.

As a non-illustrated alternative, the camera 10 may be arranged on the top plate 3, and an aperture for the lens aperture 12 of the camera 10 may be provided in the top plate 3. It is also possible that the aperture 9 into the object chamber O may instead be provided through one of the side walls 2, and that non-illustrated prisms or mirrors in the object chamber O permit observation or photographing of the object. The tray 14 for placement of the object may be inclined on the bottom plate 4, which may allow direct observation or photographing of the object through an aperture in one of the side walls 2 into the object chamber O.

The inside of the top plate and the bottom plate is advantageously matt black, and the inside of the side wall is preferably white or black, although this cannot be seen from the drawings.

Furthermore, as shown in FIG. 5, a sleeve-shaped shade 16 of said Opal plastic is provided around each one of the fluorescent tubes to further diffuse the light. In an advantageous embodiment of the illumination box 1, the side walls 2 and the bottom plate are rectangular, the bottom plate 4 having a long side and a short side. The long side has an internal length of 90 cm and the short side has an internal length of 62 cm, which correspond to the length and breadth of the screening frame 7. The screening frame has a thickness, measured on a level with the light diaphragm 5, of 10 cm. Furthermore, the height between the interior bottom of the drawer 13 and the light diaphragm 5 is 51 cm, and the height between the light diaphragm 5 and the inside of the top plate 3 is 20 cm. The centrally located aperture 9 in the light diaphragm is square, having a breadth and length of 14.5 cm. In this embodiment of the illumination box 1 four fluorescent tubes having the aforementioned specifications are provided, one along each side wall 2. A sleeve-shaped shade 16 of said Opal plastic having an outer diameter of 5 cm is arranged around each one of the fluorescent tubes 6. The shade 16 is 2-3 cm longer than the fluorescent tube 6, and thus extends past the fluorescent tube 6 at each end thereof. The thickness of the light diaphragm 5 and the shade 16 is about 3 mm.

In the aforementioned embodiment all the fluorescent tubes 6 are placed at exactly the same height in the illumination box 1, and all reflective surfaces of the fluorescent tubes 6, camera 10, walls 2 and top plate 3 are covered, as this is considered to be an important factor for an optimal result.

In an embodiment based on the aforementioned embodiment, the illumination box 1 according to the present invention is used for verifying prediction equations for visual colour, pigment content and fat content in salmon, these criteria being important for the quality classification of the salmon, and which thus have a major effect on the wholesale price thereof. Here, it should be mentioned that colour evaluation of salmon has previously been carried out visually by the Applicant using the aforementioned Skretting box, and by manual comparison of each salmon fillet with a Roche colour rule.

The starting point for calculating prediction equations for visual colour, chemical content of pigment and fat has been based on RGB values arrived at by calculating average values in a defined large area of the salmon fillets. Salmon have varying colour and fat content depending on where in the salmon measurements are made. Salmon has a stronger visual colour and a higher pigment content at the back of the fish than at the front, whilst the reverse is true for fat. The Applicant has therefore chosen to use the area of the fish that is described in the Norwegian standard “Norsk Kvalitet Snitt” (NKS, NS 9401). This is the area between the anus and the dorsal fin of the fish. Average RGB values are thus measured in an elliptical area across the spine (centred with respect to longitudinal muscle segments), and cover the whole longitudinal direction of the NKS area.

First, to document a relationship between the colour scale (Roche colour rule) that is used today for visual evaluation of salmon and the Applicant's RGB values, six colour rules were photographed six times. The position of each individual rule was changed between each image so that each individual rule had all positions in the image. Since each rule consists of 15 shades of red (colour nos. 20-34), there was a total of 540 individual observations. A regression analysis based on the RGB values from all 540 individual observations showed a statistically reliable (p<0.0001) relationship between the RGB values obtained in the Applicant's image analysis and the commercial colour scale developed by Roche for use in the visual evaluation of the colour of salmon (see FIG. 6). Of the total variation of red found in the commercial colour rule produced by Roche, the Applicant manages to explain 98.6% (R²) by systematic changes in measured RGB values; in other words, an almost exact colour reproduction.

Therefore, there is a scientific basis for asserting that the Applicant's standardisation and light setting of the illumination box provides a basis for distinguishing shades of red, and thus being able objectively to evaluate the visual colour of the salmon in accordance with the colour values used by Roche.

As evidence of the applicability of the illumination box, a test was carried out on fish material where a large spread of quality characteristics was expected. Twelve salmon from the weight classes 1, 2, 3 and 4 kilos were photographed and analysed with respect to RGB values in the NKS area and in a corresponding area in front of the dorsal fin. Each salmon was thus analysed at two different points in order, if possible, to be able to document variations in the salmon, a total of 24 observations. The same areas of the fish were analysed with respect to visual colour, chemical pigment and fat content.

By regression analysis a statistically reliable relationship (p<0.0001) was found between measured RGB values and visual evaluation of the colour of the salmon. Of the total variation in visually evaluated red in accordance with the commercial colour rule produced by Roche, 89.3% (R²) is explained by changes in measured RGB values (see FIG. 7).

As for visual colour, a statistically reliable relationship (p<0.0001) was found between measured RGB values and chemical content of pigment in the salmon. Of the total variation in pigment (range 3.5-10.0 mg/kg), measured RGB values explained 85.6% of analysed chemical values (see FIG. 8).

A statistically reliable relationship (p<0.0001) was also found between measured RGB values and chemical content of fat in the salmon. Of the total variation in fat content (range 7.6-23.3%), measured RGB values explained 64.5% of analysed chemical values (see FIG. 9).

The slightly lower relationship of the analysed values compared with the Roche rule may be connected with the fact that, unlike the colour rule, all analyses are subject to analysis variations.

To examine whether the photostandardisation managed to detect differences in fat and colour at the front and back of the salmon, and to compare analysed and RGB predicted values, comparisons in one fish were made. FIG. 10 shows very good conformity between analysed and RGB predicted values, and both sets of values show that the salmon has a higher fat content at the front than at the back, whilst the opposite was found for both visual and chemical colour.

In the case of the aforementioned exemplary embodiment, the required specifications for the camera are that the aperture and shutter values are not altered from image to image, and that the CCD chip is kept at a stable temperature so that the RGB values do not change during exposure.

Therefore, in the exemplary embodiment the camera used was of the type Sinarback 23 HR, 2000×3000 pixels, 1-4-16 shot with a piezoplate for true RGB colour registration. The CCD chip is kept at a stable temperature using a Peltier element and fan. A CCD chip with Bayer Pattern and 36 MB raw filter with 14-bit colour depth was used. The camera system has means for accurate colour calibration and shading function. Calibration takes place via a Gretag Mackbeth colour card for 24 colours, and the glass irregularities of the lens are compensated for via said shading function. The shutter system in the Sinarcam 2 unit has great precision as regards aperture control and shutter time repeatability. The camera control program (Mac-based) allows for the control and drive of image files. The ambient working temperature is within the range of +5±45° C., and the relative humidity is within the range of 5-80%.

In the exemplary embodiment the camera 10 was arranged on the top plate 3, i.e., outside the illumination box 1, an aperture for the lens aperture 12 of the camera 10 was provided in the top plate 3, a further aperture 9 was provided in the centre of the light diaphragm 5 and a black, channel-forming bellows 11 was arranged between the two apertures, as described above.

1. An illumination box for true, reproducible colour reproduction of an object, comprising side walls, a top plate and a bottom plate, wherein between the top plate and the bottom plate there is provided a light diaphragm which divides the illumination box into a light chamber above the light diaphragm and an object chamber beneath the light diaphragm, which light diaphragm admits and diffuses light from a plurality of light sources arranged in the light chamber, characterised in that the light diaphragm is attached to an essentially light-impenetrable screening frame adjacent to the side walls, with the plurality of light sources distributed along the side walls at a distance from the side walls and from the screening frame such that an area for placement of the object is screened from essentially all direct light from the plurality of light sources, and that an aperture is provided in the object chamber for observation of the object.

2. An illumination box according to claim 1, characterised by being essentially closed to external light.

3. An illumination box according to claim 1, characterised in that the light diaphragm is arranged essentially parallel to the bottom plate.

4. An illumination box according to claim 1, characterised in that the aperture is in the form of a hole in a central area of the light diaphragm for photographing the object using a camera located on the top plate, and that there are also provided light-impenetrable, non-reflective means which form a closed channel between the lens aperture of the camera and the hole in the light diaphragm.

5. An illumination box according to claim 1, characterised in that the plurality of light sources is in the form of a plurality of fluorescent tubes, preferably of the type with the specifications 55W, about 5800 Kelvin.

6. An illumination box according to claim 1, characterised in that the bottom plate in the object chamber is provided with-a drawer for insertion and withdrawal of the object.

7. An illumination box according to claim 1, characterised in that the inside of the top plate and the bottom plate is matt black, and that the inside of the side walls is white or black.

8. An illumination box according to claim 1, characterised in that the aperture and shutter values of the camera are not altered from image to image, and that the CCD chip of the camera is kept at a stable temperature so that RGB values are not changed during exposure.

9. An illumination box according to claim 1, characterised in that a sleeve-shaped shade of diffuser material surrounds each of the plurality of fluorescent tubes.

10. An illumination box according to claim 1, characterised in that the number of fluorescent tubes is four.
